(19) United States
(12) Patent Application Publication
(10) Pub. No.: US 2018/0031740 A1
(43) Pub. Date: Feb. 1, 2018

(54) SELF-CLEANING OPTIC APPARATUSES AND AUTOMOBILES WITH SELF-CLEANING OPTIC APPARATUSES

(71) Applicant: GM GLOBAL TECHNOLOGY OPERATIONS LLC, Detroit, MI (US)

(72) Inventors: MICHAEL D. ALARCON, MARKHAM (CA); MAHMOUD H. ABD ELHAMID, TROY, MI (US); ANTHONY L. SMITH, TROY, MI (US); PAUL W. ALEXANDER, YPSILANTI, MI (US); ADAM F. GROSS, LOS ANGELES, CA (US)

(73) Assignee: GM GLOBAL TECHNOLOGY OPERATIONS LLC, Detroit, MI (US)

(21) Appl. No.: 15/222,182

(22) Filed: Jul. 28, 2016

(51) Int. Cl. G02B 1/18; B60R 1/04; B60R 1/06; F21S 8/10; G02B 5/08

(52) U.S. Cl. CPC G02B 1/18; F21S 48/30; G02B 5/0891; F21S 48/1233; B60R 1/0602; B60R 1/04; B60R 2300/8066

(57) ABSTRACT

Self-cleaning optic apparatuses and automobiles with self-cleaning optic apparatuses are provided. An exemplary self-cleaning optic apparatus includes an optic device for transmitting or receiving light. The optic device is located in a chamber. The self-cleaning optic apparatus further includes a window for transmitting the light. Also, the self-cleaning optic apparatus includes a photocatalytic coating on a surface of the window. Energy emitted from within the chamber activates a photocatalytic reaction in the photocatalytic coating.

### TECHNICAL FIELD

The technical field generally relates to optic apparatuses with self-cleaning windows or lenses, and, more specifically, to optic apparatuses in automobiles with self-cleaning windows or lenses for improving driver vision.

### BACKGROUND

Conventional vision aids enabling a driver to monitor the surroundings around an automobile include externally-mounted headlamps (i.e., mounted external of the automobile occupant cabin), externally-mounted side view mirrors and internally-mounted rear view mirrors (i.e., mounted within the automobile occupant cabin). Modern automobiles often utilize externally-mounted rearview or backup video cameras as vision aids for viewing by the driver through a live video display presented on the instrument panel or dashboard. Also, modern automobiles frequently include externally-mounted sensors, such as infrared (IR) sensors that emit and receive IR light, for use in alerting the driver by visual, auditory or tactile alert of close obstruction or an approaching vehicle or pedestrian.

Whether a headlamp emitting light, a mirror reflecting light, a camera receiving visible light, or a sensor emitting and receiving IR light, optic devices mounted on an automobile include transparent windows or lenses made of glass or transparent plastic, such as polycarbonate or acrylic. These windows may include a plurality of layers to reduce glare or undesired reflection, depending on use. Typically, a window is mounted or otherwise coupled to a housing that is coupled to the automobile.

During use, the windows may become obstructed by dirt or by other particulate that may obscure the desired transmission of light through, or reflection of light from, the windows. For example, in snowy climates, salt, sand, ash, or other substances may be deposited on road surfaces to help melt snow and ice and to increase traction. As a result, a slush may be formed and deposited onto the exterior of vehicles traveling upon such roads. Even a thin layer of slush on a headlamp window significantly decreases the apparent candle power of the headlamp. Likewise, mirrors, cameras and sensors may be rendered effectively useless by slush, dirt, dust or other obstructions on the particular optic device window.

Some manufacturers have outfitted optic devices with dedicated wipers on optic device windows. However, such wipers may not be suitable for small size windows such as for mirrors, cameras or sensors. Further, such wipers may be ineffective or prone to breaking or malfunctioning. Even if successful in eliminating obstructions from windows, such wipers add manufacturing cost and may increase costs and complexity in automobile maintenance.

Accordingly, it is desirable to provide improved optic apparatuses, such as self-cleaning optic apparatuses. In addition, it is desirable to provide automobiles with self-cleaning optic apparatuses. Furthermore, other desirable features and characteristics will become apparent from the subsequent detailed description and the appended claims, taken in conjunction with the accompanying drawings and the foregoing technical field and background.

### SUMMARY

Self-cleaning optic apparatuses and automobiles with self-cleaning optic apparatuses are provided. An exemplary self-cleaning optic apparatus includes an optic device for transmitting or receiving visible light. The optic device is located in a chamber. The self-cleaning optic apparatus further includes a window for transmitting the visible light. Also, the self-cleaning optic apparatus includes a photocatalytic coating on a surface of the window. Energy emitted from within the chamber activates a photocatalytic reaction in the photocatalytic coating.

In another embodiment, a self-cleaning optic apparatus includes a housing and a window coupled to the housing and configured to reflect or transmit visible light. Further, the self-cleaning optic apparatus includes a photocatalytic coating on a surface of the window. Also, the self-cleaning optic apparatus includes an energy generating device coupled to the housing and configured to direct energy at the photocatalytic coating on the surface of the window. The energy activates a photocatalytic reaction in the photocatalytic coating.

In another embodiment, an automobile with a self-cleaning optic apparatus is provided. The automobile includes a body and a housing coupled to the body and forming a chamber. The automobile includes an optic device located in the chamber and configured to receive visible and/or infrared (IR) light. Further, the automobile includes a window bounding the chamber and configured to transmit the visible and/or IR light to the optic device. Also, the automobile includes a photocatalytic coating on a surface of the window. The automobile further includes an ultraviolet (UV) light generating device coupled to the housing and configured to direct UV light energy at the photocatalytic coating on the surface of the window. The UV light energy activates a photocatalytic reaction in the photocatalytic coating.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DESCRIPTION OF THE DRAWINGS

The embodiments will hereinafter be described in conjunction with the following drawing figures, wherein like numerals denote like elements, and wherein:

FIG. 1 is a schematic view of an automobile having a self-cleaning optic apparatus in accordance with an embodiment;

FIG. 2 is a cross section view of a self-cleaning optic apparatus of FIG. 1 in accordance with an embodiment;

FIG. 3 is a cross section view of a self-cleaning optic apparatus of FIG. 1 in accordance with another embodiment;

FIG. 4 is a cross section view of a self-cleaning optic apparatus of FIG. 1 in accordance with another embodiment; and

FIG. 5 is a cross section view of a window of a self-cleaning optic apparatus of FIGS. 2-4 in accordance with an embodiment.

### DETAILED DESCRIPTION

The following detailed description is merely exemplary in nature and is not intended to limit the self-cleaning optic apparatuses and automobiles with self-cleaning optic apparatuses or the application and uses of embodiments described herein. Furthermore, there is no intention to be bound by any expressed or implied theory presented in the preceding technical field, background, brief summary or the following detailed description.

The following description refers to elements or features being “connected” or “coupled” together. As used herein, “connected” may refer to one element/feature being mechanically joined to (or directly communicating with) another element/feature, and not necessarily directly. Likewise, “coupled” may refer to one element/feature being directly or indirectly joined to (or directly or indirectly communicating with) another element/feature, and not necessarily mechanically. However, it should be understood that although two elements may be described below, in one embodiment, as being “connected,” in alternative embodiments similar elements may be “coupled,” and vice versa. Thus, although the schematic diagrams shown herein depict exemplary arrangements of elements, additional intervening elements, devices, features, or components may be present in an actual embodiment.

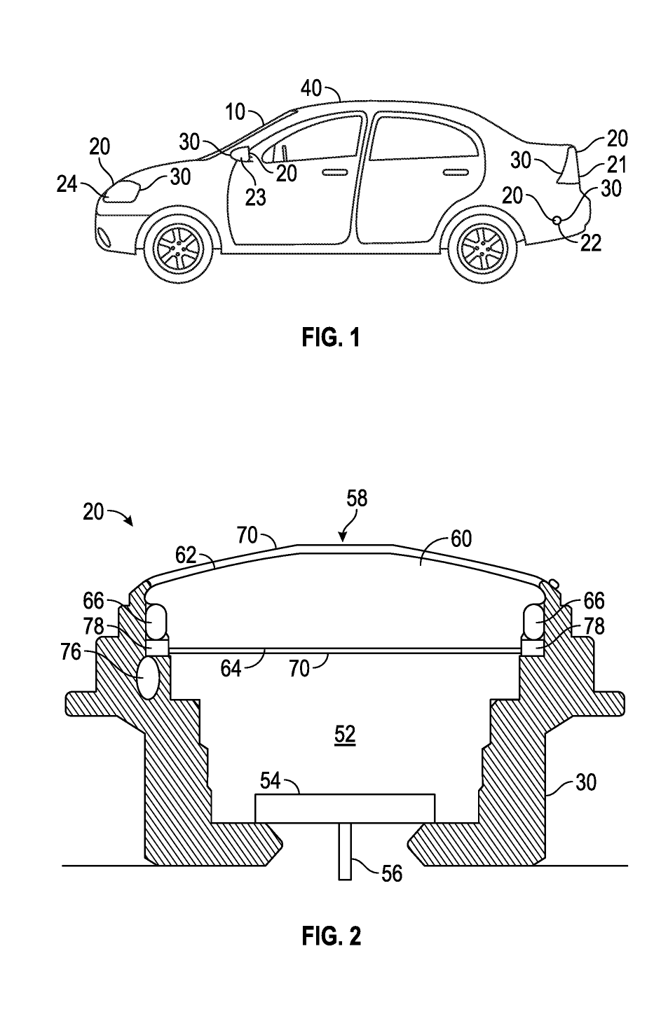

Further, various components and features described herein may be referred to using particular numerical descriptors, such as first, second, third, etc., as well as positional and/or angular descriptors, such as horizontal and vertical. However, such descriptors may be used solely for descriptive purposes relating to drawings and should not be construed as limiting, as the various components may be rearranged in other embodiments. It should also be understood that FIGS. 1-5 are merely illustrative and may not be drawn to scale.

FIG. 1 illustrates a vehicle (or “automobile”) 10 provided with self-cleaning optic apparatuses 20, according to an embodiment herein. The automobile 10 may be any one of a number of different types of automobiles, such as, for example, a sedan, a wagon, a truck, or a sport utility vehicle (SUV).

In the embodiment of FIG. 1, the self-cleaning optic apparatus 20 may be an externally-mounted rearview or backup video camera 21; a sensor 22, such as an IR sensor; an externally-mounted side mirror 23; and/or a headlamp 24. Each configuration of the self-cleaning optic apparatus 20, despite use as a camera 21, sensor 22, mirror 23 or headlamp 24, includes a housing 30 coupled to a body 40 of the automobile 10.

FIG. 2 illustrates, in cross-section view, an exemplary self-cleaning optic apparatus 20. As shown, the exemplary self-cleaning optic apparatus 20 of FIG. 2 includes a housing 30 that surrounds a chamber 52. An optic device 54 is located in the chamber 52. An exemplary optic device 54 is a camera sensor that receives and records visible light, a lamp that emits visible light, or a sensor that emits and receives IR light. The self-cleaning optic apparatus 20 may include another type of optic device 54 as desired for use. As shown, an electrical connection 56 may be coupled to the optic device 54 and extend out of the chamber 52 to a signal processing device and/or a power source provided elsewhere.

The housing 30 further defines an opening 58 through which light may pass into and/or out of the chamber 52. As shown in FIG. 2, a window 60 is positioned in the opening 58 to protect components within the chamber 52. The window 60 may enhance aerodynamics of the automobile 10. An exemplary window 60 is formed from a transparent material such as glass or plastic such as polycarbonate. The window 60 may include a plurality of layers of transparent materials and may include gaps between such layers that form vacuums or are filled with gas. The window 60 may be formed as a lens to direct or refract light to a focus.

Regardless of the specific structure of the window 60, the window 60 has an exterior surface 62 and an opposite interior surface 64. In the embodiment of FIG. 2, the interior surface 64 may be considered to enclose the chamber 52 such that the window 60 is external or outside of the chamber 52. Alternatively, the exterior surface 62 may be considered to enclose the chamber 52 such that the window 60 is within the chamber 52. In the exemplary embodiment of FIG. 2, a seal 66, such as an O-ring, is located between the window 60 and the housing 30 to seal the chamber 52 and prevent water or other debris from entering the chamber 52.

In the embodiment of FIG. 2, the self-cleaning optic apparatus 20 further includes a photocatalytic coating 70 on the exterior surface 62 and/or on the interior surface 64 of the window 60. A photocatalytic coating 70 on the exterior surface 62 of window 60 may be considered to be an external photocatalytic coating referring to its location relative to chamber 52. A photocatalytic coating 70 on the interior surface 64 of window 60 may be considered to be an internal photocatalytic coating referring to its location relative to chamber 52.

An exemplary photocatalytic coating 70 is a transparent electrically conductive oxide. For example, the photocatalytic coating 70 may comprise titanium dioxide (TiO₂) or other metal oxides such as zinc oxide (ZnO), tin oxide (SnO₂), or cerium oxide (CeO₂). Titanium dioxide, particularly when it is at least partially crystalline in the “anatase” crystallographic form, serves, under the effect of radiation, particularly ultraviolet radiation, to catalyze the oxidation of organic molecules by free radical reactions. Such oxidation results in the degradation of organic molecules.

The underlying physical mechanism of the catalytic oxidation provided by the photocatalytic coating 70 is the creation of an electron-hole pair under the effect of the radiation whereof the energy is greater than or equal to the energy “band gap” between the valence and conduction bands of titanium dioxide. With a band gap of from about 3.2 to about 3.3 EV, a titanium dioxide coating on glass absorbs UV light photons having wavelengths in the range of from about 375 to about 386 nanometers, creating positive holes in the valence band of the titanium dioxide that are known as strong oxidizing entities.

Such photocatalytic coatings also have photoinduced hydrophilic properties conferring self-cleaning functions on the coating material. The coating surface made hydrophilic in fact allows for easy cleaning, both of organic waste and inorganic dust, for example by rainwater. This hydrophilic property also confers an anti-fogging effect on the coating material, as water has a tendency to form on the coating material as a transparent film rather than as discrete droplets. Photocatalytic titanium dioxide coatings can be formed by various deposition methods, for example, by chemical vapor deposition (CVD), by cathode sputtering, or by “sol-gel” processes.

In the embodiment of FIG. 2, the self-cleaning optic apparatus 20 further includes an energy generating device 76, such as a light energy generating or light generating device. An exemplary light energy generating device 76 generates UV light, though other light energy may be generated if suitable to support the photocatalytic coatings to catalyze oxidation by free radical reactions of organic molecules. In an exemplary embodiment, the light generating device 76 is a light-emitting diode (LED) or a plurality of LEDs. Such light generating devices 76 have low power usage but provide sufficient light energy to support photocatalytic activity of the photocatalytic coating 70.

The light generating device 76 may be oriented to direct light at the photocatalytic coating 70 on the exterior surface 62 and/or at the photocatalytic coating 70 on the interior surface 64 of the window 60 at a desired angle. Alternatively, the self-cleaning optic apparatus 20 may be provided with an optical waveguide or waveguides 78 coupled to the light generating device 76 to direct light energy emitted therefrom onto the photocatalytic coating 70 on the exterior surface 62 and/or onto the photocatalytic coating 70 on the interior surface 64 of the window 60 at a desired angle. For example, the optical waveguide may include fiber optic filament. In an exemplary embodiment, the optical waveguide is annular, i.e., circumferential, and is located outside the periphery of the window 60. In certain embodiments, the self-cleaning optic apparatus 20 may include a first light generating device 76 dedicated to direct light energy emitted therefrom onto a photocatalytic coating 70 on the exterior surface 62 of the window 60 and a second light generating device 76 dedicated to direct light energy emitted therefrom onto a photocatalytic coating 70 on the interior surface 64 of the window 60. Such an embodiment may include first and second optical waveguides for directing light onto the respective external or internal photocatalytic coatings 70.

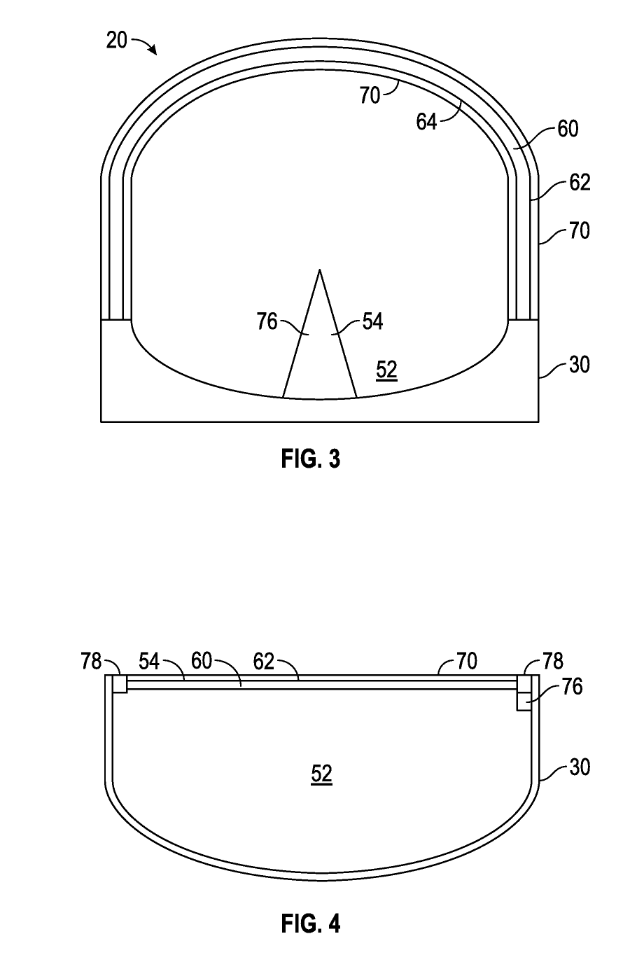

FIG. 3 illustrates, in cross section view, an alternate embodiment in which the self-cleaning optic apparatus 20 is not provided with an optic device 54 and light generating device 76 separately, i.e., not with a dedicated light generating device 76 as in FIG. 2. Rather, in FIG. 3, the optic device 54 is itself a light generating device 76. For example, the optic device 54 in FIG. 3 is a headlamp that generates and transmits light. It is noted that modern headlamps emit visible and UV light.

As shown, the exemplary self-cleaning optic apparatus 20 of FIG. 3 includes a housing 30 and window 60 that surround a chamber 52. The optic device 54 is located in the chamber 52 and is mounted to the housing 30. As shown, a photocatalytic coating 70 is located on the exterior surface 62 and on the interior surface 64 of the window 60. Alternatively, the photocatalytic coating 70 may be located on only one of the surfaces 62 or 64. An exemplary photocatalytic coating 70 is a transparent electrically conductive oxide such as titanium dioxide (TiO₂). During use, UV light from the optic device 54 supports the photocatalytic coatings 70 to catalyze oxidation by free radical reactions of organic molecules. Visible light from the optic device 54 may be transmitted through the window 60 to illuminate areas around the automobile 10 (shown in FIG. 1).

Cross-referencing FIGS. 2 and 3, it may be seen that the embodiment of the self-cleaning optic apparatus 20 in FIG. 2 includes a separate light energy generating device 76 to provide energy to the photocatalytic coating 70 to support oxidation and self-cleaning. Alternatively, in the embodiment of FIG. 3, the optic device 54 is a headlamp that transmits visible light for illumination and UV light that provides energy to the photocatalytic coating 70 to support oxidation and self-cleaning.

FIG. 4 illustrates, in cross section view, another alternate embodiment in which the self-cleaning optic apparatus 20 is not provided with a separate optic device 54 and window 60. Rather, in FIG. 4 the optic device 54 is a mirror formed by the window 60 and includes a reflective exterior surface 62.

As shown, the exemplary self-cleaning optic apparatus 20 of FIG. 4 includes a housing 30. The housing 30 surrounds a chamber 52 in which the optic device 54 is located. As shown, a photocatalytic coating 70 is located on the reflective exterior surface 62 of the window 60 of the optic device 54. An exemplary photocatalytic coating 70 is a transparent electrically conductive oxide such as titanium dioxide (TiO₂).

Further, the self-cleaning optic apparatus 20 includes a light generating device 76. As shown, the light generating device 76 is coupled to the housing 30 and oriented to direct light onto the photocatalytic coating 70. An exemplary light generating device 76 generates UV light. An exemplary light generating device 76 is a light-emitting diode (LED) or diodes (LEDs). In the exemplary embodiment, the self-cleaning optic apparatus 20 includes an optic waveguide 78 to direct light from the light generating device 76 onto the photocatalytic coating 70. An exemplary optic waveguide 78 is annular and surrounds the periphery of the mirrored window 60. The exemplary optic waveguide 78 may direct UV toward the mirrored window 60 from along the mirror periphery. In an exemplary embodiment, the optic waveguide 78 is in direct contact with the mirrored window 60 along the mirror periphery. If the optic waveguide 78 is not utilized in the embodiment of FIG. 4, then the light generating device 76 is directly contacted with the mirrored window 60 along the mirror periphery to direct light onto the photocatalytic coating 70.

Cross-referencing FIG. 4 with FIGS. 2 and 3, it may be seen that the embodiment of the self-cleaning optic apparatus 20 in FIG. 4 directs energy at the exterior surface 62 of the window 60 from a location outside of the chamber 52 rather than from inside chamber 52. The light generating device 76 itself may be located within chamber 52 as in FIGS. 2 and 3. However, the light energy is transmitted onto the exterior surface 62 of the window 60 from a location outside of the chamber 52, i.e., on the external side of the exterior surface 62, in FIG. 4.

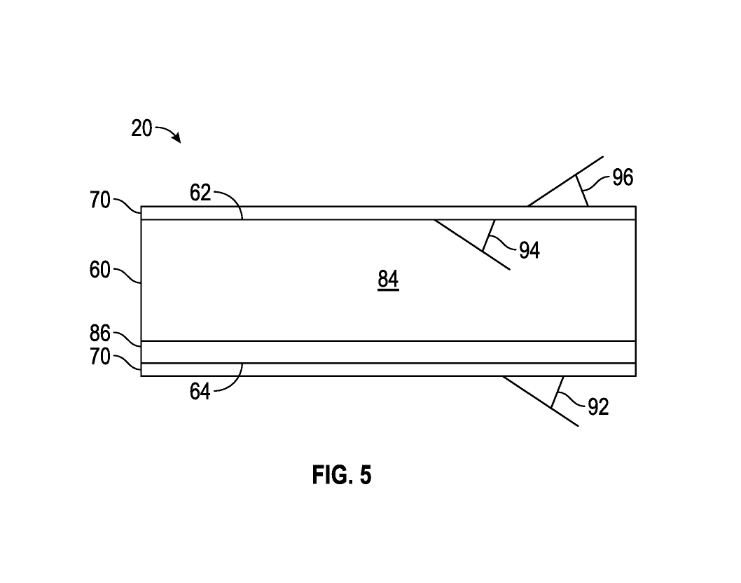

FIG. 5 illustrates, in cross section view, the window 60 of an exemplary self-cleaning optic apparatus 20 in more detail. As shown, the window 60 includes a transparent layer or a plurality of transparent layers that form a transparent substrate 84. In FIG. 5, the window 60 further includes a low refractive index coating 86. As used herein, a “low refractive index coating” has a refractive index n of about 1.3 or less. An exemplary low refractive index coating may be formed from a stack of dielectric materials. Such a coating 86 may be used to reflect light emitted from the light generating device 76 (shown in FIGS. 2-4) in certain embodiments. For example, for the embodiment of FIG. 2 that utilizes a camera as the optic device 54, the light emitted from the light generating device 76 may be reflected within the chamber 52 and then reflected back into contact with the photocatalytic coating 70. By preventing passage through the window 60 (and loss) of the light emitted from the light generating device 76, the efficiency of conversion of light generation to photocatalytic activity is raised. It is noted that UV light reflected within the chamber 52 will not have any negative effects on camera imaging of visible light by the optic device 54.

As shown, the photocatalytic coating 70 is located on the exterior surface 62 of the window 60 and on the interior surface 64 (formed by the low refractive index coating 86) of the window 60. In exemplary embodiments, the photocatalytic coating 70 may be located on either or both of the surfaces 62 and 64. Further, FIG. 5 illustrates an angle of incidence 92 of light directed onto the photocatalytic coating 70 on interior surface 64 from an interior source, such as a light generating device located in the chamber 52 of the self-cleaning optic apparatus 20 of the embodiment of FIG. 2 or 3. Further, FIG. 5 illustrates an angle of incidence 94 of light directed onto the photocatalytic coating 70 on exterior surface 62 from an interior source, such as a light generating device located in the chamber 52 of the self-cleaning optic apparatus 20 of the embodiment of FIG. 2 or 3. Also, FIG. 5 illustrates an angle of incidence 96 of light directed onto the photocatalytic coating 70 on exterior surface 62 from an exterior source, such as a light generating device of the self-cleaning optic apparatus 20 of the embodiment of FIG. 4.

In embodiments of the self-cleaning optic apparatus 20 herein, it is contemplated that the angle of incidence 92, angle of incidence 94, and/or angle of incidence 96 be greater than about 0°. Further, it is contemplated that angle of incidence 92, angle of incidence 94, and/or angle of incidence 96 be less than about 90°, such as less than about 30°, less than about 25°, less than about 25°, less than about 20°, less than about 15°, or less than about 10°. It has been found that directing light onto the photocatalytic coating 70 at a desired angle of incidence improves the efficiency of conversion of light generation to photocatalytic activity.

Embodiments provided herein provide for improved self-cleaning of optic devices having windows or lenses that may become obscured by dirt, dust, particulates or other debris. The inclusion of dedicated energy-generating devices for supporting catalytic reactions may be of particular benefit at night when no solar energy is available or for windows or lenses that are downward-facing or otherwise shielded from the sun. Also, embodiments herein are particularly suited for cleaning large or thick accumulations over windows or lenses wherein sunlight is completely blocked and cannot reach the windows or lenses.

For an embodiment in which the optic device 54 is a headlamp, such as in FIG. 3, the exterior surface 62 of the window 60 may be kept clean from debris through the photocatalytic activity of the coating on the exterior surface. Further, for such an embodiment, condensation on the interior surface of the window 60 is prevented or minimized through the photocatalytic activity of the coating on the interior surface. For an embodiment in which the optic device 54 is a mirror, such as in FIG. 4, the exterior reflective surface of the mirror (window) may be kept clean from debris and clear from condensation through the photocatalytic activity of the coating on the exterior surface 62.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A self-cleaning optic apparatus comprising:
an optic device for transmitting or receiving light, wherein the optic device is located in a chamber;
a window for transmitting the light; and
a photocatalytic coating on a surface of the window, wherein energy emitted from within the chamber activates a photocatalytic reaction in the photocatalytic coating.

2. The self-cleaning optic apparatus of claim 1 wherein the optic device is a lamp that transmits visible light and UV light, and wherein the UV light is the energy emitted from within the chamber that activates the photocatalytic reaction in the photocatalytic coating.

3. The self-cleaning optic apparatus of claim 1 wherein the window has an interior surface enclosing the chamber and an exterior surface, and wherein the photocatalytic coating is located on the exterior surface.

4. The self-cleaning optic apparatus of claim 1 wherein the window has an interior surface enclosing the chamber and an exterior surface, wherein the photocatalytic coating includes an internal photocatalytic coating on the interior surface and an external photocatalytic coating on the exterior surface, and wherein energy emitted from within the chamber activates a photocatalytic reaction in the internal photocatalytic coating and in the external photocatalytic coating.

5. The self-cleaning optic apparatus of claim 1 wherein the optic device is a camera that receives visible light transmitted by the window.

6. The self-cleaning optic apparatus of claim 1 wherein the optic device is a camera that receives visible light transmitted by the window, and wherein the self-cleaning optic apparatus further comprises a light-emitting diode (LED) for emitting ultraviolet (UV) light energy onto the photocatalytic coating.

7. The self-cleaning optic apparatus of claim 1 wherein the optic device is a camera that receives visible light transmitted by the window, and wherein the self-cleaning optic apparatus further comprises:
a light-emitting diode (LED) for emitting ultraviolet (UV) light energy; and
an optical waveguide coupled to the LED to direct the UV light energy onto the photocatalytic coating.

8. The self-cleaning optic apparatus of claim 1 wherein the photocatalytic coating has a low refractive index and is configured to reflect the energy back into the chamber.

9. The self-cleaning optic apparatus of claim 1 wherein:
the window has an exterior surface;
the window includes a low refractive index coating forming an interior surface and is configured to reflect the energy emitted from within the chamber; and
the photocatalytic coating is located on the interior surface.

10. A self-cleaning optic apparatus comprising:
a housing,
a window coupled to the housing and configured to reflect or transmit light;
a photocatalytic coating on a surface of the window; and
an energy generating device coupled to the housing and configured to direct energy at the photocatalytic coating on the surface of the window, wherein the energy activates a photocatalytic reaction in the photocatalytic coating.

11. The self-cleaning optic apparatus of claim 10 wherein the window forms a reflective mirror.

12. The self-cleaning optic apparatus of claim 10 wherein the self-cleaning optic apparatus further comprises an optical waveguide coupled to the housing and coupled to the energy generating device to direct energy onto the photocatalytic coating.

13. The self-cleaning optic apparatus of claim 10 wherein the energy generating device is a light-emitting diode (LED) for emitting ultraviolet (UV) light energy, and wherein the self-cleaning optic apparatus further comprises an optical waveguide coupled to the housing and coupled to the LED to direct UV light onto the photocatalytic coating.

14. The self-cleaning optic apparatus of claim 10 wherein the housing forms a chamber, and wherein the self-cleaning optic apparatus further comprises an optic device located in the chamber for receiving visible light transmitted through the window.

15. The self-cleaning optic apparatus of claim 10 wherein the housing forms a chamber, and wherein the self-cleaning optic apparatus further comprises a camera located in the chamber for receiving visible light transmitted through the window.

16. The self-cleaning optic apparatus of claim 10 wherein:
the housing forms a chamber;
the self-cleaning optic apparatus further comprises an optic device located in the chamber for receiving visible light transmitted through the window;
the window has an interior surface enclosing the chamber and an exterior surface;
the photocatalytic coating includes an internal photocatalytic coating on the interior surface and an external photocatalytic coating on the exterior surface; and
the energy generating device includes an external energy generating device coupled to the housing and configured to direct energy at the external photocatalytic coating and an internal energy generating device coupled to the housing and configured to direct energy at the internal photocatalytic coating, wherein the energy activates a photocatalytic reaction in the external photocatalytic coating and in the internal photocatalytic coating.

17. An automobile with a self-cleaning optic apparatus comprising:
a body;
a housing coupled to the body and forming a chamber;
an optic device located in the chamber and configured to receive visible and/or infrared (IR) light;
a window bounding the chamber and configured to transmit the visible and/or IR light to the optic device;
a photocatalytic coating on a surface of the window; and
an ultraviolet (UV) light generating device coupled to the housing and configured to direct UV light energy at the photocatalytic coating on the surface of the window, wherein the UV light energy activates a photocatalytic reaction in the photocatalytic coating.

18. The automobile of claim 17 wherein the UV light generating device is a light-emitting diode (LED).

19. The automobile of claim 17 wherein the window has an interior surface enclosing the chamber and an exterior surface, and wherein the photocatalytic coating is located on the exterior surface.

20. The automobile of claim 17 wherein the window has an interior surface enclosing the chamber and an exterior surface, and wherein the photocatalytic coating includes an internal photocatalytic coating located on the interior surface and an external photocatalytic coating located on the exterior surface.
